(19) United States
(12) Patent Application Publication
(10) Pub. No.: US 2009/0088121 A1
(43) Pub. Date: Apr. 2, 2009

(54) High Linearity and Low Noise Mixer

(75) Inventors: Nianwei Xing, Mountain View, CA (US); David H. Shen, San Jose, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS INC. (CAYMAN), Santa Clara, CA (US)

(21) Appl. No.: 12/236,726

(22) Filed: Sep. 24, 2008

Related U.S. Application Data
(60) Provisional application No. 60/975,771, filed on Sep. 27, 2007.

(51) Int. Cl. H04B 1/18

(52) U.S. Cl. 455/319

(57) ABSTRACT

Circuits and methods for a mixer circuit involve having a first transistor with first and second terminals, where the first terminal is configured to handle an input RF signal. The mixer has a second transistor including a first terminal coupled to the second terminal of the first transistor, a second terminal configured to handle an input oscillator signal, and a third terminal configured to output an intermediate frequency (IF) signal. The IF signal includes a mixed product of the input RF signal and the input oscillator signal. A gate oxide thickness of the first transistor is less than a gate oxide thickness of the second transistor to provide enhanced linearity and a low noise figure. One or more of the mixers can be implemented in a receiver design.

### CROSS-REFERENCE TO RELATED APPLICATIONS

This application claims priority to U.S. Provisional Application No. 60/975,771, filed on Sep. 27, 2007, the disclosure of which is incorporated by reference.

### TECHNICAL FIELD

This disclosure relates to mixer circuits, for example, in radio frequency (RF) applications.

### SUMMARY

In general, in some aspects, a mixer circuit includes a first transistor including first and second terminals, in which the first terminal is configured to handle an input RF signal. There is a second transistor including a first terminal coupled to the second terminal of the first transistor, a second terminal configured to handle an input oscillator signal, and a third terminal configured to output an intermediate frequency (IF) signal, in which the IF signal includes a mixed product of the input RF signal and the input oscillator signal. A gate oxide thickness of the first transistor is less than a gate oxide thickness of the second transistor.

This and other implementations can optionally include one or more of the following features, which also may optionally be in any combination. The mixer circuit can include a single balanced architecture, which may be a folded mixer circuit. The mixer circuit can include at least one element to match an impedance of the first transistor with an RF source impedance, in which at least one element includes a capacitor, an inductor, a resistor and/or an impedance. The mixer circuit can have a first impedance-matching inductor and a second impedance-matching inductor coupled to the first transistor, where the first and second impedance matching inductors can be configured to match an impedance of the first transistor with an RF source impedance. The first terminal of the first transistor can be coupled to a first impedance-matching inductor, in which the first transistor includes a third terminal. The third terminal can be coupled to the second impedance-matching inductor, and the second impedance-matching inductor may be coupled to a ground terminal. The mixer circuit can include a double balanced architecture. The mixer circuit can be a folded mixer circuit. The mixer circuit can have at least one element to match an impedance of the first transistor with an RF source impedance. The mixer circuit can have a third transistor coupled to the first transistor to form a differential input for the input RF signal. The mixer circuit can include at least two transistors configured to handle a differential input oscillator frequency signal. The mixer circuit can include at least two pairs of transistors to handle a differential input RF signal. The at least two pairs of transistors can include a first set of cross-coupled terminals for handling the differential input RF signal, and a second set of cross-coupled terminals to output a differential intermediate frequency (IF) signal. The mixer circuit can have at least two power supply voltages, and the first transistor may be coupled to a lower power supply voltage than the second transistor. The mixer circuit can include at least two pairs of transistors configured to handle a differential input oscillator frequency signal. The gate oxide thickness of the first transistor can be less than 80 Angstroms. The mixer circuit can have metal-oxide-semiconductor field-effect transistor (MOSFET) devices. A gate oxide thickness of the first transistor can be less than a gate oxide thickness of any other transistors in the mixer circuit.

In other implementations, some aspects include a method for manufacturing a mixer circuit. The method includes coupling a first terminal of a first transistor to an input RF signal, where the first terminal of the first transistor is configured to handle the input RF signal. The method coupling a second terminal of the first transistor to at least one terminal of a second transistor, coupling a first terminal of the second transistor to the second terminal of the first transistor, coupling a second terminal of the second transistor to an input oscillator frequency signal. The second terminal of the second transistor is configured to handle the input oscillator frequency signal. The method involves coupling a third terminal of the second transistor to output an intermediate frequency (IF) signal, in which the third terminal of the second transistor is configured to handle the IF signal, and the IF signal includes a mixed product of the input RF signal and the input oscillator frequency signal. A gate oxide thickness of the first transistor is less than a gate oxide thickness of the second transistor.

This and other implementations can optionally include one or more of the following features, which also may optionally be in any combination. The method can include forming a gate oxide of the first transistor for a thickness of less than 80 Angstroms. The method can include forming the gate oxide of the first transistor for a thickness that is less than a gate oxide thickness of any other transistors in the mixer circuit. The method can include coupling a bias transistor to one or more nodes of the mixer circuit, and forming the bias transistor with a gate oxide thickness that is greater than the gate oxide thickness of the second transistor. The method can include coupling the transistors to form an architecture comprising one of a single balanced architecture, a single balanced folded architecture, a double balanced architecture, and/or a double balanced folded architecture. The method can include coupling the first transistor to a power supply terminal that is different from a power supply terminal of the second transistor. The method may involve coupling the first terminal of the first transistor to a first impedance-matching inductor, in which the first transistor includes a third terminal, coupling the third terminal of the first transistor to the second impedance-matching inductor, and coupling the second impedance-matching inductor to a ground terminal.

In general, some other implementations involve aspects for a method for a mixer circuit including at least one radio frequency (RF) device coupled to at least one switching device. The method involves receiving an input RF signal at a first RF device terminal of at least one RF device, in which the RF device includes a second RF device terminal coupled to a first switching device terminal of at least one switching device. The method involves receiving an input oscillator frequency signal at a second switching device terminal of at least one switching device, mixing the input RF signal and the input oscillator frequency signal to generate an intermediate frequency (IF) signal, and outputting the IF signal at a third switching device terminal of the switching device. A gate oxide thickness of the RF device is less than a gate oxide thickness of the switching device. The RF device and the switching device include metal-oxide-semiconductor field-effect transistor (MOSFET) devices.

This and other implementations can optionally include one or more of the following features, which also may optionally be implemented in various combinations. The gate oxide thickness of the RF device is less than 80 Angstroms. The mixer circuit can include an architecture including one of a single balanced architecture, a single balanced folded architecture, a double balanced architecture, and/or a double balanced folded architecture. The gate oxide thickness of the RF device can be less than a gate oxide thickness of any other device in the mixer circuit. The method can include utilizing the switching device as a switch when mixing the signals. The method can include utilizing a first power supply voltage for the RF device, and utilizing a second power supply voltage for the switching device, in which he first power supply voltage can be less than the second power supply voltage.

In general, some implementations include aspects for a mixer circuit that involves at least one radio frequency (RF) device that includes a first RF device terminal for handling an input RF signal, and a second RF device terminal coupled to at least one terminal of at least one switching device. The at least one switching device includes a first switching device terminal coupled to the second RF device terminal, a second switching device terminal for handling an input oscillator frequency signal, and a third switching device terminal to output an intermediate frequency (IF) signal, in which the IF signal includes a mixed product of the input RF signal and the input oscillator frequency signal. A gate oxide thickness of the at least one RF device is less than a gate oxide thickness of the at least one switching device. An impedance of the at least one RF device is matched with an RF source impedance. The at least one RF device and the at least one switching device comprise metal-oxide-semiconductor field-effect transistor (MOSFET) devices.

This and other implementations can optionally include one or more of the following features, which also may optionally be implemented in various combinations. The mixer circuit can include at least one element to match the impedance of the at least one RF device with the RF source impedance, in which at least the one element includes a capacitor, an inductor, a resistor and/or an impedance. The mixer circuit can have a first impedance-matching inductor and a second impedance-matching inductor, in which the first and second impedance matching inductors includes impedances to match an impedance of the at least one RF device with an RF source impedance. The first RF device terminal can be coupled to a first impedance-matching inductor. The at least one RF device can include a third RF device terminal, and the third RF device terminal can be coupled to the second impedance-matching inductor. The second impedance-matching inductor can be further coupled to a ground terminal. The mixer circuit can include at least two RF devices for a differential input RF signal, at least two switching devices for a differential input oscillator frequency signal, at least two pairs of switching devices, in which the at least two pairs of switching devices can include a first set of cross-coupled terminals for handling a differential input oscillator frequency signal, and a second set of cross-coupled terminals to output a differential intermediate frequency (IF) signal. The at least one radio frequency (RF) device can include a gate oxide thickness of less than 80 Angstroms, and a gate oxide thickness of the at least one RF device can be less than a gate oxide thickness of any other devices in the mixer circuit.

In general, other implementations include aspects for a method for manufacturing a mixer circuit. The method for manufacturing the mixer circuit includes coupling a first RF device terminal of at least one radio frequency (RF) device to handle an input RF signal, coupling a second RF device terminal of the at least one RF device to at least one terminal of at least one switching device, coupling a first switching device terminal of the at least one switching device to the second RF device terminal, coupling a second switching device terminal of the at least one switching device to handle an input oscillator frequency signal. The method also includes coupling a third switching device terminal of the at least one switching device to output an intermediate frequency (IF) signal, in which the IF signal includes a mixed product of the input RF signal and the input oscillator frequency signal, and forming a gate oxide of the at least one RF device for a thickness of less than 80 Angstroms. The gate oxide thickness of the at least one RF device is less than a gate oxide thickness of the at least one switching device.

In general, other implementations includes aspects for a receiver that includes an antenna to receive a radio frequency (RF) signal, an RF filter to filter the RF signal, at least one oscillator to generate an oscillator signal, at least one low noise amplifier (LNA) to amplify the filtered RF signal, at least one mixer to mix the amplified filtered RF signal with the oscillator signal, and a low pass filter to receive an output of the mixer and generate a baseband input signal. The mixer includes a first transistor that includes first and second terminals, in which the first terminal is configured to handle an input RF signal. The mixer includes a second transistor that includes a first terminal coupled to the second terminal of the first transistor, a second terminal configured to handle an input oscillator signal, and a third terminal configured to output an intermediate frequency (IF) signal. The IF signal includes a mixed product of the input RF signal and the input oscillator signal. A gate oxide thickness of the first transistor is less than a gate oxide thickness of the second transistor.

In general, other implementations includes aspects for a receiver. The receiver includes an antenna to receive a radio frequency (RF) signal, an RF filter coupled to the antenna to filter the RF signal, a low noise amplifier (LNA) coupled to the RF filter, a first oscillator coupled with a first mixer. The first mixer includes at least one first mixer input transistor and at least one first mixer switching transistor, and the at least one first mixer input transistor includes a gate oxide thickness that is thinner than a gate oxide thickness of the at least one first mixer switching transistor. The first mixer is configured to perform image rejection and mix an output signal of the LNA with an output signal of the first oscillator. The receiver also includes an intermediate frequency (IF) filter coupled to an output of the first mixer, an IF amplifier coupled to an output of the IF filter, and a second oscillator coupled to a second mixer. The second mixer includes at least one second mixer input transistor and at least one second mixer switching transistor, in which the at least one second mixer input transistor includes a gate oxide thickness that is thinner than a gate oxide thickness of the at least one second mixer switching transistor. The second mixer is configured to mix an output signal of the IF amplifier with an output signal of the second oscillator. The receiver also includes a low pass filter to filter an output of the second mixer and to generate a baseband input signal.

These and other implementations can optionally include one or more of the following features. The system can include any combination of one or more components for receivers, transmitters, and transceivers, in which a mixer can be coupled to any of the one or more components or their sub-components. Control circuits may include a digital circuit or a microprocessor. Any of the methods, designs, and techniques described herein can also be implemented in a system, an apparatus, a circuit, device, a machine, or in any combination thereof.

The details of one or more implementations of the disclosure are set forth in the accompanying drawings and the description below. Other features, aspects, and advantages of the disclosure can be apparent from the description, drawings, and claims.

### DESCRIPTION OF THE DRAWINGS

FIG. 1 is a schematic of an example of a folded mixer circuit in a single balanced architecture.

FIG. 2 is a schematic of an example of a mixer circuit in a single balanced architecture.

FIG. 3 is a schematic of an example of a folded mixer circuit in a double balanced architecture.

FIG. 4 is a schematic of an example of a mixer circuit in a double balanced architecture.

FIG. 5 is a schematic of an example of a mixer circuit in single balanced architecture with an input device having an impedance matched to an RF source impedance.

FIG. 6 is a schematic of an example of a mixer circuit in a double balanced architecture with the input devices having an impedance matched to a RF source impedance.

FIG. 7 is a schematic of an example of a low intermediate frequency (IF) receiver.

FIG. 8 is a schematic of an example of a direct-conversion receiver.

### DETAILED DESCRIPTION

Many RF transceivers may require a mixer when converting frequencies. A “dynamic range” can be one characteristic that is addressed in mixer designs. In particular, the dynamic range may be referred to as a measurement or ratio between the maximum and minimum signals the mixer can process without significant distortion. Dynamic range may also refer to a range of power over which the mixer provides useful operation, or an amplitude range over which the mixer can operate without degradation of performance. In some implementations, the dynamic range can be bounded by a conversion compression point for high input signals, and by the noise figure (NF) of the mixer for low level input signals. Generally, the minimum input signal power that a mixer can process can be determined by the mixer's NF while the maximum input signal power a mixer can process is determined by the mixer's linearity.

The NF can be defined as the ratio of input signal-to-noise-ratio to output signal-to-noise-ratio, which may be expressed as shown below in equation (1):

$$NF = 10 {log}_{10} ( \frac{{( S / N )}_{in}}{{( S / N )}_{out}} ) = 10 {log}_{10} ( \frac{G \cdot {N}_{in} + {N}_{added}}{G \cdot {N}_{in}} ) \qquad ( 1 )$$

In equation (1), S can represent the power of the signal, N can represent the power of the noise, and G can represent the circuit gain. Particularly, Nᵢₙ can represent the input noise, and N_{added} can represent the noise generated by the mixer itself. As N_{added} decreases, the total NF also decreases.

Linearity may refer to a measurement of how precisely the output signal, either in terms of voltage or power, can track the input signal as a linear function of the input signal. There can be multiple parameters that may be used to evaluate the linearity of the mixer, such as, the 3^{rd}-order input intercept point (IIP3), or the 1 dB gain compression point (P1dB). The linearity of the input device and of the output load together with the power supply may limit the overall linearity of the circuit. Due to a channel carriers' velocity saturation and mobility degradation, using short channel transistors for the input stage can result in better linearity. Also, with a fixed channel length, a higher power supply can result in a higher output swing while maintaining sufficient linearity.

Noise in Complementary Metal Oxide Semiconductor (CMOS) devices may be considered as being primarily attributable to thermal noise and flicker noise. Thermal noise can be caused by the random thermal motion of the channel carriers in the CMOS device. The power spectral density of the thermal noise may be expressed as shown below in equation (2):

$$\overline{{i}_{ds}^{2}} = 4 KT {γg}_{d 0} \qquad ( 2 )$$

In equation (2), K can represent Boltzmann's Constant (1.38×10⁻²³ V·C/K), T can represent the absolute temperature, g_{d0} can represent the drain-source conductance at zero V_{ds}, and y can represent a constant that has a value of about ⅔ for long channel devices. Thermal noise may sometimes be referred to as white noise because its power spectral density can be “flat” up to about 10¹² Hz. Depending on where the CMOS device is located in the circuit, the operating transconductance can be altered to reduce the thermal noise.

Flicker noise can result from the release of trapped electrons or holes. In particular, dangling bonds may be present at the interface of the gate oxide at the end of the crystal lattice and the substrate of the CMOS transistor. When electrons or holes travel through this area, they can be trapped and then later released, introducing “flicker” noise in the drain current. The power of the flicker noise current may be expressed as shown below in equation (3):

$$\overline{{i}_{nd}^{2}} = \frac{{K}_{p}}{f} \frac{{g}_{m}^{2}}{{WLC}_{ox}} \qquad ( 3 )$$

In equation (3), Kₚ can represent a process-dependent constant, gₘ can represent the transconductance of the MOS transistor, W and L can represent the width and length of the transistor, respectively, COX can represent the gate oxide capacitance per unit area, and f can represent the flicker frequency. A spectral density of flicker noise can be inversely proportional to frequency.

At a given frequency, the power density of flicker noise is inversely proportional to the area of the MOS device. Thus, beyond altering frequency, the area of the MOS device may be altered to reduce flicker noise. However, increasing device size may introduce unwanted effects, such as, for example, increasing parasitic capacitance or slowing circuit operation. Other techniques, such as, chopper stabilization or correlated double sampling can reduce flicker noise at the price of increased complexity, high power consumption, or increasing thermal noise.

Communication systems with a direct conversion architecture and lower power supplies can have a small circuit size and low power consumption in RF transceivers, and therefore, can lower an overall cost. In direct conversion, the RF signal can be converted to the baseband signal directly to avoid the use of off-chip intermediate frequency (IF) filters. However, direct conversion systems can exhibit higher flicker noise than alternative systems. Moreover, the increased flicker noise may corrupt a weak signal before the signal is amplified. Lowering power supply may increase the possibility of creating frequency harmonics in the output signal, and thus, degrading linearity

For CMOS mixers, the input devices of the mixer can be the main contributor of noise to the mixer. As shown by equation (3) above, when Cₒₓ, the gate oxide capacitance, is increased, flicker noise decreases. Therefore, decreasing the thickness of the gate oxide layer results in increasing COX and decreasing flicker noise. Thus, by fabricating a thinner device at the input stage, the noise figure of a mixer can be lowered. CMOS devices in mixers may be fabricated with different gate oxide thickness in the same process. For example, in one fabrication technology, there can be at least three gate oxide thicknesses (e.g., on the order of 30 Angstroms, 40 Angstroms or 60 Angstroms) by some semiconductor manufactures. Other manufactures may have one or more gate oxide thicknesses in a fabrication process. In another technology, there can be gate oxide thickness of 30, 40, and 80 Angstroms, where the 30 Angstrom gate oxide is considered the thinnest gate oxide. When using, designing, or manufacturing multiple gate oxide thicknesses in the same circuit or silicon chip, the power applied to the thin gate oxide transistors can be used within the parameters specified by the manufacturer to avoid damage to the transistors. One example parameter that can be taken into consideration is the breakdown voltage limit of the thin oxide device.

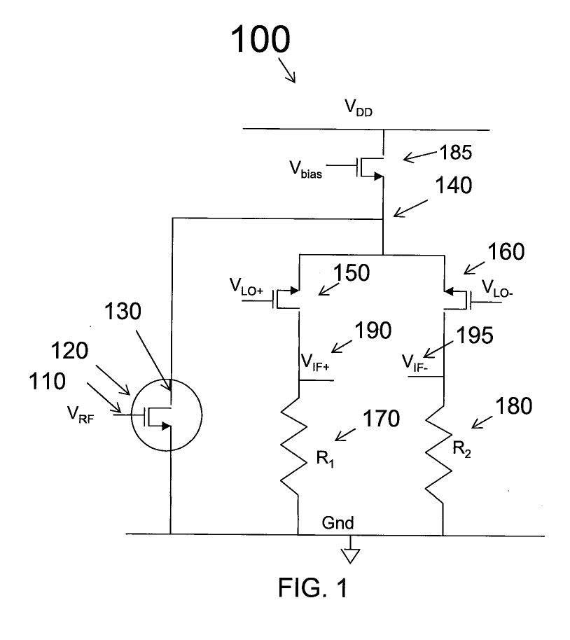

FIG. 1 is a schematic of an example of a folded mixer 100 in a single balanced architecture. The mixer 100 includes a MOS device 120 at a mixer input stage coupled to a bias device 185 and a mixer output stage. The mixer output stage includes devices 150, 160, and resistors 170, 180, where the devices 150, 160 are coupled in series with the resistors, 170, 180, respectively. The bias device 185 is coupled to the power supply voltage V_{DD}, while device 120 and resistors 170, 180 are coupled to a ground node Gnd.

The mixer 100 can be considered a single, balanced mixer 100 that mixes a single-ended input RF signal V_{RF} and a differential local oscillator (LO) signal, (V_{LO+}−V_{LO-}). In the mixer 100, the Radio Frequency (RF) input signal V_{RF}, which has a frequency of ω_{RF} is applied to the input terminal 110 for the single ended input signal V_{RF}. The MOS device 120 generates a current of the same frequency ω_{RF} at the drain terminal 130 of device 120. The current from the device 120 is added to the bias current of device 150 and device 160 at a shared node 140. Devices 150 and 160 can be switching transistors with gate terminals driven by, for example, a differential square wave LO signal at frequency ω_{LO}. The differential output signal is a differential intermediate frequency (IF) signal (V_{F+}−V_{IF-}). The differential output signal at output terminals 190, 195 from device 150 and device 160, respectively, are the mixed products of the RF signal V_{RF} and the local oscillator (LO) signal (V_{LO+}−V_{LO-}) using mixed frequencies (ω_{RF}+ω_{LO}), (ω_{RF}−ω_{LO}) and ω_{LO}. The output currents can be converted to voltages V_{IF+}, and V_{IF-} by resistors R₁ 170 and R₂ 180 at output terminals 190 and 195, respectively. In some implementations, a filter can follow the mixer 100 to filter unwanted signals.

In some implementations, the power supply voltage V_{DD} of the mixer 100 may be designed to have a specified voltage breakdown value of the thinner oxide transistor, e.g., device 120. This requirement may be a factor in the performance of the devices 150 and 160. Device 185 can be a bias transistor controlled by the reference voltage V_{bias}.

The device 120 of the mixer input stage can be a device that has a shorter channel and a thinner gate oxide than the other devices 150, 160, 185 of the mixer to reduce the 1/f flicker noise in the signal that propagates through the mixer. The devices 150 and 160 can have a gate oxide thickness that is thicker than the gate oxide of device 120 to increase a gain of the output voltage. Devices 150 and 160 are switching transistors that may be less affected by the flicker noise, and thus, may be thicker oxide transistors such that higher power supply can be used to improve the mixer linearity. In some implementations, a 30 Angstrom gate oxide (e.g., a thin gate oxide) can be used for device 120 and a 60 Angstrom gate oxide (e.g., a thicker gate oxide) can be used for devices 150, 160, and 185. In other implementations, gate oxide thicknesses of 30, 40 and/or 60 Angstroms can be used to implement the mixer, in which the bias device 185 can have a different gate oxide thickness than the switching devices 150 and 160, while device 120 is implemented with 30 Angstrom gate oxide thickness.

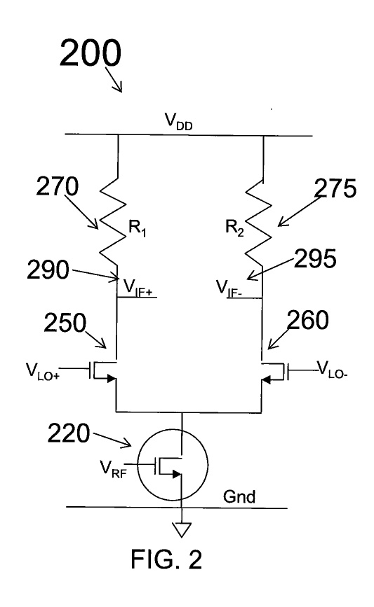

FIG. 2 is a schematic of an example of a mixer circuit in a single balanced architecture. The mixer 200 includes a differential pair of devices 250, 260 coupled in series with resistor loads 270, 275, respectively. Differential output terminals 290, 295 are located between the differential pair of devices 250, 260, and the resistor loads 270, 275, respectively. The differential pair of devices 250, 260 are coupled in series to input device 220. The operation of the mixer 200 can be similar to that of the mixer 100 of FIG. 1. For example, in this architecture, device 220 can be the thin gate oxide device while devices 250 and 260 can be the thick gate oxide devices. The differential output IF signal (V_{IF+}−V_{IF-}) is located at the respective output terminals 290 and 295. The voltage supplied to the drain of the thin oxide device, device 220, can be the mixer supply power V_{DD} minus the voltage drops across the serially-connected device 250 and resistor 270. Therefore, the devices 250 and 260 can have a higher power input than that to device 220.

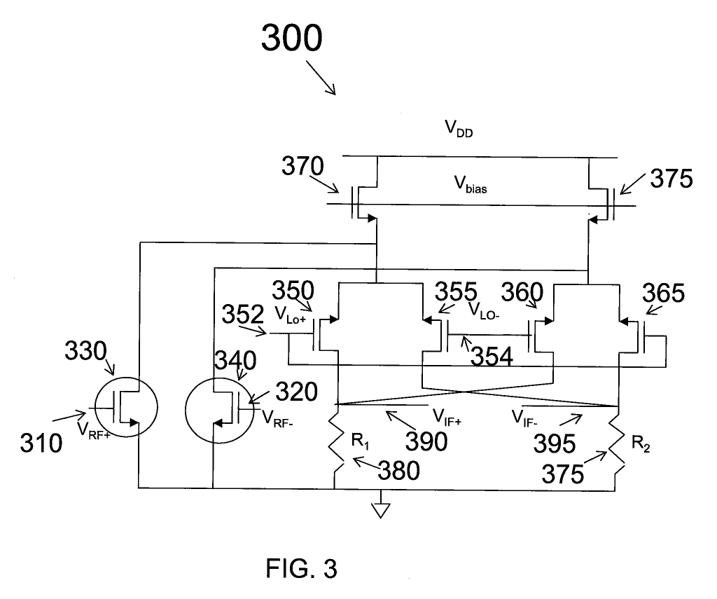

FIG. 3 is a schematic of an example of a folded mixer circuit in a double balanced architecture. The mixer 300 includes an input mixer stage for the input RF signal (V_{RF+}−V_{RF-}) with differential input RF devices 330, 340 with respective input terminals 310, 320. The mixer 300 includes bias devices 370, 375 coupled to the differential input RF devices and an output stage, coupled to a differential input LO signal (V_{LO+}−V_{LO-}), that includes a pair of differential, cross-coupled switching devices 350, 355, 360, 365, with resistors 380, 385 coupled to ground. Each of the differential input RF devices 330, 340 couples to one of the two bias devices 370, 375, and one of the pair of switching devices 350, 355, 360, 365. Output terminals 390, 395 are coupled between resistors 380, 385 and the cross-coupled devices 350, 355, 360, 365 for the differential output IF signal (V_{IF+}−V_{IF-}). The differential input LO signal (V_{LO+}−V_{LO-}) can be applied on the cross-coupled gate terminals 352, 354 of the pair of differential, cross-coupled switching devices 350, 355, 360, 365.

The operation of the mixer circuit 300 can be similar to that of the mixer 100 of FIG. 1, except the output signal spectrum may not include the LO frequency ω_{LO}. In this architecture, input devices 330, 340 can be the thin gate oxide devices while the biasing devices 370, 375, and switching devices 350, 355, 360, and 365 can be thick gate oxide transistors. For fabrication processes with more than two types of gate oxide layers, the bias devices 370, 375 can have thicker gate oxides than the gate oxides of the switching devices 350, 355, 360, 365. For some implementations, a thin gate oxide of 30 nm can be used for devices 330 and 340.

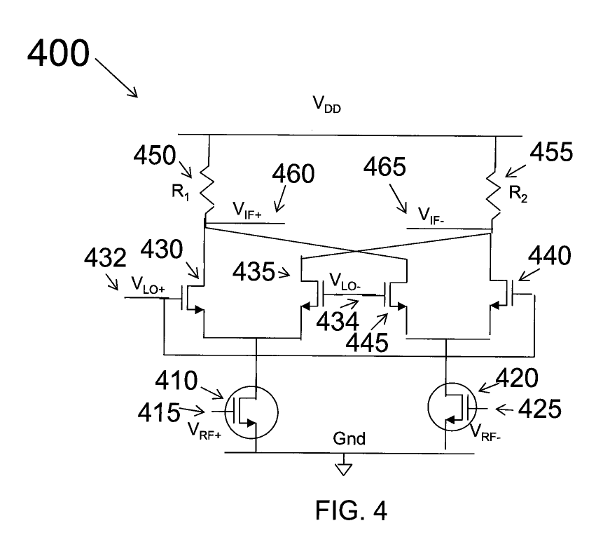

FIG. 4 is a schematic of an example of a mixer circuit in a double balanced architecture. The mixer 400 includes an input stage with differential input RF devices 410, 420 having input terminals 415, 425, respectively, for an input RF signal (V_{RF+}−V_{RF-}). The differential input RF devices 410, 420 couple to an output stage coupled to a differential LO signal (V_{LO}+−V_{LO-}), where each device 410, 410 couples to one of a pair of differential, cross-coupled switching devices 430, 435, 445, 440 that are coupled to resistors 450, 455, which are coupled to a power supply. Output terminals 460, 465 are coupled between resistors 450, 455 and cross-coupled switching devices 430, 435, 440, 440 for the differential output IF signal (V_{IF+}−V_{IF-}). The differential input LO signal (V_{LO+}−V_{LO-}) is on the cross-coupled gate terminals 432, 434 of the pair of differential, cross-coupled switching devices 430, 435, 445, 440.

The operation of the mixer 400 can be similar to that of the mixer circuit 300 of FIG. 3. In the mixer 400, devices 410, 420 can be the thin gate oxide devices while devices 430, 435, 440 and 445 can be the thick gate oxide devices.

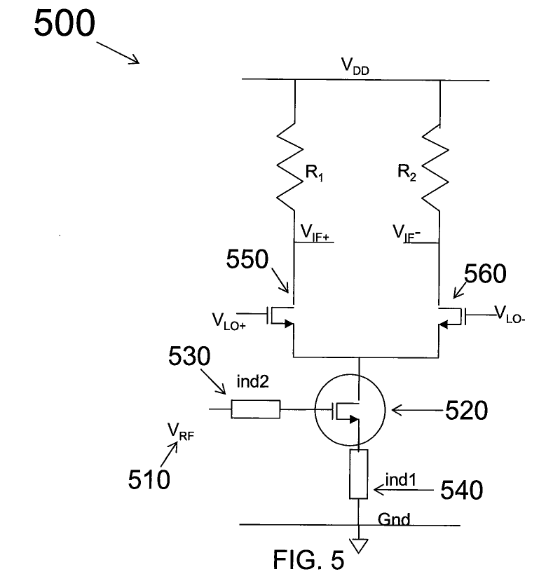

FIG. 5 is a schematic of an example of a mixer circuit in a single balanced architecture with an input device having an impedance matched to an RF source impedance. The design of the mixer 500 in FIG. 5 can be similar to the mixer 200 of FIG. 2, except the mixer 500 of FIG. 5 has a first inductor 540 coupled between the input RF device 520 and ground, and a second inductor 530 coupled between the input RF terminal 510 and the gate of the input RF device 520.

The operation of the mixer 500 can be similar to that of the mixer circuit 200 of FIG. 2. In mixer 500, the first inductor 540 can be an inductor that is in series with the source of input RF device 520 in order to generate a real impedance at the input RF terminal 510. The second inductor 530 can be an inductor that is used to resonate with a gate capacitance of device 520 at ω_{RF}. The input RF device 520 can have a thin gate oxide device while devices 550, 560 can be the thick gate oxide devices. In some implementations, the impedance matching may be capacitive, inductive, resistive, or an impedance network with any combination of capacitive, inductive, or resistive elements and/or impedances.

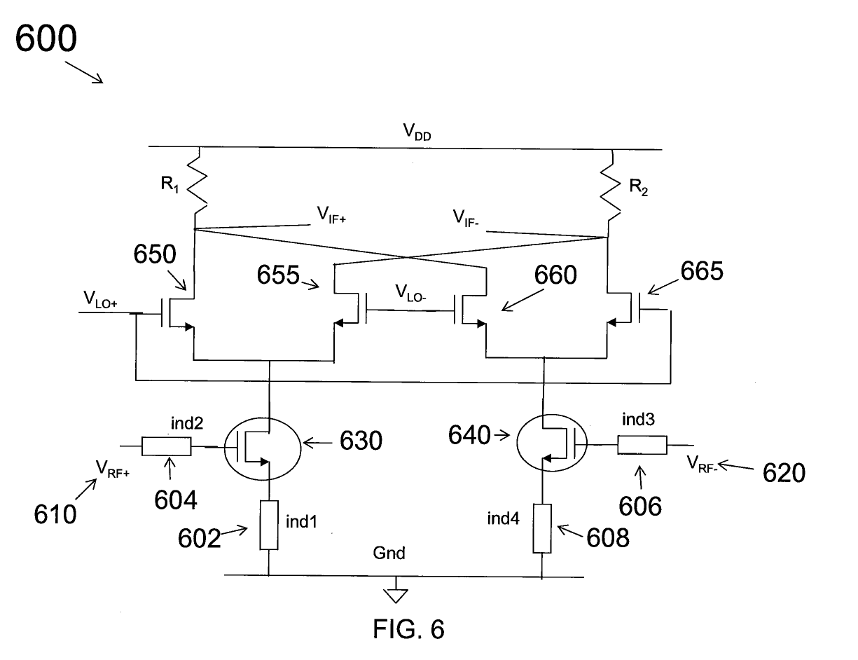

FIG. 6 is a schematic of an example of a mixer circuit 600 in a double balanced architecture with the input devices having an impedance matched to an RF source impedance. The design of the mixer 600 can be similar to the mixer 400, except the mixer 600 has a first inductor 602 coupled between input RF device 630 and a ground node, a second inductor 604 coupled between the input RF device 630 and an input RF terminal 610, a third inductor 606 coupled between the input RF device 640 and an input RF terminal 620, and a fourth inductor coupled 608 between the input RF device 640 and the ground node. The mixer 600 can be similar to mixer 400 of in operation, except in mixer 600 the input devices 630, 640 can have impedances that are matched to an RF source impedance. Devices 630, 640 can be the thin gate oxide device, while devices 650, 655, 660, 665 can be thick gate oxide devices.

In most of the above implementations, in order to improve the linearity at the output load, the power supply voltage can be selected according to the thick gate oxide devices because the thick gate oxide devices can have a higher breakdown voltage than the thinner gate oxide devices provided the voltage applied to the thinner gate oxide devices are lower than a breakdown voltage of the thinner gate oxide device. In some implementations, the thinner gate oxide devices can be coupled to a lower voltage power supply voltage than the thicker gate oxide devices. For example, in one technology, devices having a 60 Angstrom gate oxide thickness can operate at 2.5 V, and the devices having a 30 Angstrom gate oxide thickness can operate at 1.8V.

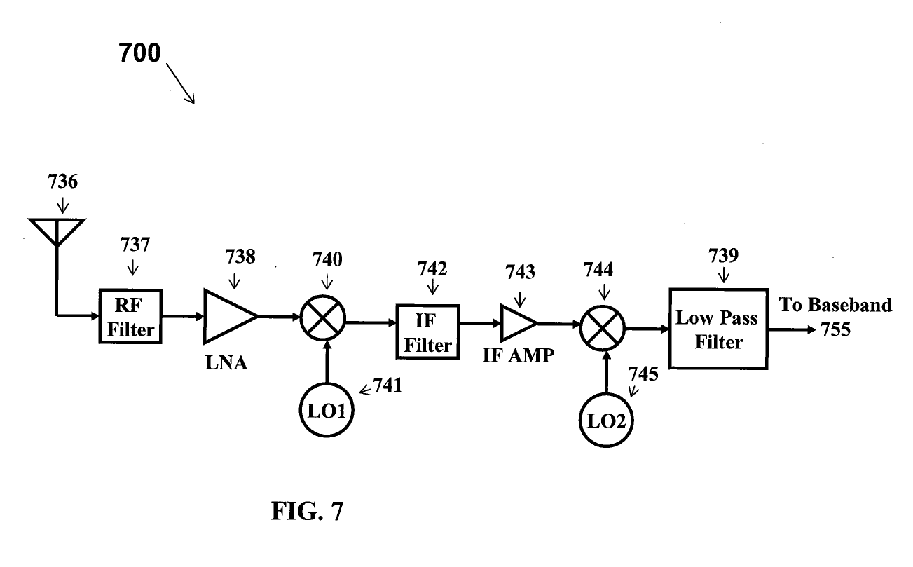

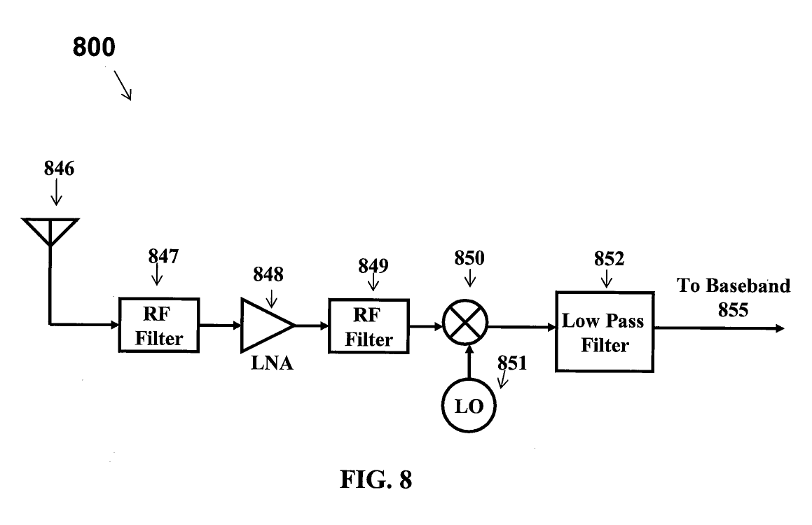

The disclosed techniques can be used with wireless communication systems. For example, the disclosed techniques can be used with receivers, transmitters, and transceivers for both wireless and wireline applications. FIGS. 7 and 8 are two examples of systems in which the mixer techniques described above can be used.

FIG. 7 is a schematic of an example of a low intermediate frequency (IF) receiver 700. The receiver 700 has an antenna 736 coupled to an RF filter 737. The RF filter 737 is coupled to a low noise amplifier (LNA) 738. The LNA 738 is coupled to a first mixer 740. The first mixer 740 is also coupled to a first local oscillator (LO) 741 and an intermediate frequency (IF) filter 742. The IF filter 742 is coupled to an IF amplifier 743. The IF amplifier 743 is coupled to a second mixer 744. The second mixer 744 is coupled to a second local oscillator 745 and a low-pass filter 739 at the output of the mixer 700 to send an output signal to a baseband circuit 755 (not shown).

In operation, an RF signal arriving at the antenna 736 passes through the RF filter 737, and to the LNA 738. In some implementations, an image filter may be coupled between the LNA 738 and the first mixer 740 to produce a band-limited RF signal. The RF signal enters the first mixer 740, which translates the RF signal down to an intermediate frequency by mixing the RF signal with a signal produced by the first LO 741. Some or all undesired mixer products in the IF signal are rejected by an IF filter 742. The filtered IF signal then enters an IF amplifier 743, after which the outputs from the IF amplifier 743 feed into the second mixer 744. The second mixer 744 translates that signal down to yet another intermediate frequency by mixing the signal with the signal produced by a second LO 745. The first mixer 740 and/or the second mixer 744 can use the mixer techniques described above. The signal from the second mixer 744 is low-pass filtered in a low pass filter 739, and that filtered signal is sent to a baseband circuit 755 for processing. Tuning into a particular channel within the band-limited RF signal can be accomplished by varying the frequency of the local oscillators 741, 745.

FIG. 8 is a schematic of an example of a direct-conversion receiver 800. The receiver 800 has an antenna 846 coupled to a first RF filter 847. The first RF filter 847 is coupled to an LNA 848. The LNA 848 is coupled to a second RF filter 849. The second RF filter is coupled to a mixer 850. The mixer 850 is coupled to a local oscillator 851 and a low pass filter 852. The output of the low pass filter 852 can be sent to a baseband circuit 855 (not shown).

In operation, the antenna 846 couples an input RF signal through the first bandpass RF filter 847 and into the LNA 848. The signal from the LNA 848 can proceed through a second RF filter 849. The RF filter 849 can generate a band-limited RF signal, which can enter the mixer 850 and to mix with a LO frequency produced by the LO 851. The mixer 850 may use any of the mixer techniques described above. The signal from the mixer 850 can be coupled into a low pass filter 852 before proceeding into a baseband circuit 855. Information sent to the baseband circuit 855 can be used by other components of a communications system. In some implementations, the low pass filter 852 may be an analog filter.

In some implementations, the positions of switches, resistors, or other components can be exchanged from the disclosed figures with minimal change in circuit functionality. Various topologies for circuit models can also be used, other than what is shown in the figures. The exemplary designs shown are not limited to CMOS process technology, but may also use other process technologies, such as BiCMOS (Bipolar-CMOS) process technology, or Silicon Germanium (SiGe) technology. In some implementations, switches can be implemented as transmission gate switches. The circuits can be single-ended or fully-differential circuits.

In some implementations, the techniques described in this disclosure can be used with radio architectures that support multiple communication standards, such as GSM/EDGE/WEDGE, and emerging standards, such as WiMAX, LTE, and UMB. The techniques in this disclosure can also be used with multi-band radios, GPS, RX Diversity, WLAN, and FM/DTV receivers.

Generally, implementations may involve using different gate oxide thickness in the input transistor for a mixer to improve its linearity and noise figure. In addition, the techniques described here can be used with any other analog/RF or digital algorithms used in communication systems. In one implementation, a circuit for processing radio frequency signals may include a first transistor with a first gate oxide thickness and a second transistor with a gate oxide thickness which is greater than the gate oxide thickness of the first transistor. The first transistor can be used in an input transconductance stage and the second transistor is used as part of a switched pair of transistors. In some implementations, the gate oxide thickness of the thinner gate oxide device can be in any range at or below 80 Angstroms (e.g., a range of 60 Angstroms and less, a range of 40 Angstroms and less).

The system can include other components, where the circuit can couple with those components. Some of the components may include computers, processors, clocks, radios, signal generators, counters, test and measurement equipment, function generators, oscilloscopes, phase-locked loops, frequency synthesizers, phones, wireless communication devices, and components for the production and transmission of data. The number and order of variable gain and filter stages can vary. In addition the number of controllable steps, as well as the steps sizes of each of the stages of gain can also vary. Other implementations can be within the scope of the following claims.

What is claimed is:

1. A mixer circuit comprising:
a first transistor comprising first and second terminals, the first terminal configured to handle an input RF signal; and
a second transistor comprising a first terminal coupled to the second terminal of the first transistor, a second terminal configured to handle an input oscillator signal, and a third terminal configured to output an intermediate frequency (IF) signal, wherein the IF signal comprises a mixed product of the input RF signal and the input oscillator signal,
wherein a gate oxide thickness of the first transistor is less than a gate oxide thickness of the second transistor.

2. The mixer circuit of claim 1, wherein the mixer circuit comprises a single balanced architecture.

3. The mixer circuit of claim 2, wherein the mixer circuit comprises a folded mixer circuit.

4. The mixer circuit of claim 3, wherein the mixer circuit comprises at least one element to match an impedance of the first transistor with an RF source impedance, wherein the at least one element comprises a capacitor, an inductor, a resistor or an impedance.

5. The mixer circuit of claim 1, further comprising a first impedance-matching inductor and a second impedance-matching inductor coupled to the first transistor, the first and second impedance matching inductors configured to match an impedance of the first transistor with an RF source impedance.

6. The mixer circuit of claim 5, wherein the first terminal of the first transistor is coupled to a first impedance-matching inductor, wherein the first transistor comprises a third terminal, wherein the third terminal is coupled to the second impedance-matching inductor, and wherein the second impedance-matching inductor is further coupled to a ground terminal.

7. The mixer circuit of claim 1, wherein the mixer circuit comprises a double balanced architecture.

8. The mixer circuit of claim 7, wherein the mixer circuit comprises a folded mixer circuit.

9. The mixer circuit of claim 8, wherein the mixer circuit comprises at least one element to match an impedance of the first transistor with an RF source impedance.

10. The mixer circuit of claim 1, further comprising a third transistor coupled to the first transistor to form a differential input for the input RF signal.

11. The mixer circuit of claim 1, wherein the mixer circuit comprises at least two transistors configured to handle a differential input oscillator frequency signal.

12. The mixer circuit of claim 11, wherein the mixer circuit comprises at least two pairs of transistors to handle a differential input RF signal.

13. The mixer circuit of claim 11, wherein the at least two pairs of transistors comprises:
a first set of cross-coupled terminals for handling the differential input RF signal; and
a second set of cross-coupled terminals to output a differential intermediate frequency (IF) signal.

14. The mixer circuit of claim 1, further comprising at least two power supply voltages, wherein the first transistor is coupled to a lower power supply voltage than the second transistor, wherein the mixer circuit comprises at least two pairs of transistors configured to handle a differential input oscillator frequency signal.

15. The mixer circuit of claim 1, wherein the gate oxide thickness of the first transistor is less than 80 Angstroms.

16. The mixer circuit of claim 1, wherein the mixer circuit comprises metal-oxide-semiconductor field-effect transistor (MOSFET) devices.

17. The mixer circuit of claim 1, wherein a gate oxide thickness of the first transistor is less than a gate oxide thickness of any other transistors in the mixer circuit.

18. A method for manufacturing a mixer circuit, the method comprising:
coupling a first terminal of a first transistor to an input RF signal, the first terminal of the first transistor being configured to handle the input RF signal;
coupling a second terminal of the first transistor to at least one terminal of a second transistor;
coupling a first terminal of the second transistor to the second terminal of the first transistor;
coupling a second terminal of the second transistor to an input oscillator frequency signal, the second terminal of the second transistor being configured to handle the input oscillator frequency signal; and
coupling a third terminal of the second transistor to output an intermediate frequency (IF) signal, the third terminal of the second transistor being configured to handle the IF signal, wherein the IF signal comprises a mixed product of the input RF signal and the input oscillator frequency signal,
wherein a gate oxide thickness of the first transistor is less than a gate oxide thickness of the second transistor.

19. The method of claim 18, further comprising forming a gate oxide of the first transistor for a thickness of less than 80 Angstroms.

20. The method of claim 18, further comprising forming the gate oxide of the first transistor for a thickness that is less than a gate oxide thickness of any other transistors in the mixer circuit.

21. The method of claim 18, further comprising coupling a bias transistor to one or more nodes of the mixer circuit, further comprising forming the bias transistor with a gate oxide thickness that is greater than the gate oxide thickness of the second transistor.

22. The method of claim 18, further comprising coupling the transistors to form an architecture comprising one of a single balanced architecture, a single balanced folded architecture, a double balanced architecture, or a double balanced folded architecture.

23. The method of claim 18, further comprising coupling the first transistor to a power supply terminal that is different from a power supply terminal of the second transistor.

24. The method of claim 18, further comprising:
coupling the first terminal of the first transistor to a first impedance-matching inductor, wherein the first transistor comprises a third terminal;
coupling the third terminal of the first transistor to the second impedance-matching inductor; and
coupling the second impedance-matching inductor to a ground terminal.

25. A method for a mixer circuit, the mixer circuit comprising at least one radio frequency (RF) device coupled to at least one switching device, the method comprising:
receiving an input RF signal at a first RF device terminal of at least one radio frequency (RF) device, wherein the at least one RF device comprises a second RF device terminal coupled to a first switching device terminal of at least one switching device;
receiving an input oscillator frequency signal at a second switching device terminal of the at least one switching device; and
mixing the input RF signal and the input oscillator frequency signal to generate an intermediate frequency (IF) signal; and
outputting the IF signal at a third switching device terminal of the at least one switching device,
wherein a gate oxide thickness of the at least one RF device is less than a gate oxide thickness of the at least one switching device, and
wherein the at least one RF device and the at least one switching device comprise metal-oxide-semiconductor field-effect transistor (MOSFET) devices.

26. The method of claim 25, wherein the gate oxide thickness of the at least one RF device is less than 80 Angstroms.

27. The method of claim 25, wherein the mixer circuit comprises an architecture comprising one of a single balanced architecture, a single balanced folded architecture, a double balanced architecture, and a double balanced folded architecture.

28. The method of claim 25, wherein the gate oxide thickness of the at least one RF device is less than a gate oxide thickness of any other device in the mixer circuit.

29. The method of claim 25, further comprising utilizing the at least one switching device as a switch when mixing the signals.

30. The method of claim 25, further comprising:
utilizing a first power supply voltage for the at least one RF device; and
utilizing a second power supply voltage for the at least one switching device, wherein the first power supply voltage is less than the second power supply voltage.

31. A mixer circuit comprising:
at least one radio frequency (RF) device comprising:
a first RF device terminal for handling an input RF signal,
a second RF device terminal coupled to at least one terminal of at least one switching device; and
the at least one switching device comprising:
a first switching device terminal coupled to the second RF device terminal,
a second switching device terminal for handling an input oscillator frequency signal, and
a third switching device terminal to output an intermediate frequency (IF) signal, wherein the IF signal comprises a mixed product of the input RF signal and the input oscillator frequency signal,
wherein:
a gate oxide thickness of the at least one RF device is less than a gate oxide thickness of the at least one switching device,
an impedance of the at least one RF device is matched with an RF source impedance, and
wherein the at least one RF device and the at least one switching device comprise metal-oxide-semiconductor field-effect transistor (MOSFET) devices.

32. The mixer of claim 31, wherein the mixer circuit comprises at least one element to match the impedance of the at least one RF device with the RF source impedance, wherein at least the one element comprises a capacitor, an inductor, a resistor or an impedance;
further comprising a first impedance-matching inductor and a second impedance-matching inductor, the first and second impedance matching inductors comprising impedances to match an impedance of the at least one RF device with an RF source impedance, and
wherein the first RF device terminal is coupled to a first impedance-matching inductor, wherein the at least one RF device comprises a third RF device terminal, wherein the third RF device terminal is coupled to the second impedance-matching inductor, and wherein the second impedance-matching inductor is further coupled to a ground terminal.

33. The mixer of claim 31, wherein:
the mixer circuit comprises at least two RF devices for a differential input RF signal,
the mixer circuit comprises at least two switching devices for a differential input oscillator frequency signal,
the mixer circuit comprises at least two pairs of switching devices, and
the at least two pairs of switching devices comprises:
a first set of cross-coupled terminals for handling a differential input oscillator frequency signal; and
a second set of cross-coupled terminals to output a differential intermediate frequency (IF) signal.

34. The mixer of claim 31, wherein:
the at least one RF device comprises a gate oxide thickness of less than 80 Angstroms, and
a gate oxide thickness of the at least one RF device is less than a gate oxide thickness of any other devices in the mixer circuit.

35. A method for manufacturing a mixer circuit, the method comprising:
coupling a first RF device terminal of at least one radio frequency (RF) device to handle an input RF signal;
coupling a second RF device terminal of the at least one RF device to at least one terminal of at least one switching device;
coupling a first switching device terminal of the at least one switching device to the second RF device terminal;
coupling a second switching device terminal of the at least one switching device to handle an input oscillator frequency signal;
coupling a third switching device terminal of the at least one switching device to output an intermediate frequency (IF) signal, wherein the IF signal comprises a mixed product of the input RF signal and the input oscillator frequency signal; and
forming a gate oxide of the at least one RF device for a thickness of less than 80 Angstroms, wherein the gate oxide thickness of the at least one RF device is less than a gate oxide thickness of the at least one switching device.

36. A receiver comprising:
an antenna to receive a radio frequency (RF) signal;
an RF filter to filter the RF signal;
at least one oscillator to generate an oscillator signal;
at least one low noise amplifier (LNA) to amplify the filtered RF signal;
at least one mixer to mix the amplified filtered RF signal with the oscillator signal; and
a low pass filter to receive an output of the mixer and generate a baseband input signal,
wherein the mixer comprises:
a first transistor comprising first and second terminals, the first terminal configured to handle an input RF signal; and
a second transistor comprising a first terminal coupled to the second terminal of the first transistor, a second terminal configured to handle an input oscillator signal, and a third terminal configured to output an intermediate frequency (IF) signal, wherein the IF signal comprises a mixed product of the input RF signal and the input oscillator signal,
wherein a gate oxide thickness of the first transistor is less than a gate oxide thickness of the second transistor.

37. A receiver comprising:
an antenna to receive a radio frequency (RF) signal;
an RF filter coupled to the antenna to filter the RF signal;
a low noise amplifier (LNA) coupled to the RF filter;
a first oscillator coupled with a first mixer;
the first mixer comprising at least one first mixer input transistor and at least one first mixer switching transistor, wherein the at least one first mixer input transistor comprises a gate oxide thickness that is thinner than a gate oxide thickness of the at least one first mixer switching transistor, wherein the first mixer is configured to perform image rejection and mix an output signal of the LNA with an output signal of the first oscillator;
an intermediate frequency (IF) filter coupled to an output of the first mixer;
an IF amplifier coupled to an output of the IF filter;
a second oscillator coupled to a second mixer;
the second mixer comprising at least one second mixer input transistor and at least one second mixer switching transistor, wherein the at least one second mixer input transistor comprises a gate oxide thickness that is thinner than a gate oxide thickness of the at least one second mixer switching transistor, wherein the second mixer is configured to mix an output signal of the IF amplifier with an output signal of the second oscillator; and
a low pass filter to filter an output of the second mixer and to generate a baseband input signal.
